(19) United States
(12) Patent Application Publication
(10) Pub. No.: US 2026/0063247 A1
(43) Pub. Date: Mar. 5, 2026

(54) METHOD FOR DELIVERING LIQUID HYDROGEN

(71) Applicant: L'Air Liquide, Societe Anonyme pour l'Etude et l’Exploitation des Procedes Georges Claude, Paris (FR)

(72) Inventors: Stephane DUDRET, Paris (FR); Pierre BENICHOU, Paris (FR)

(21) Appl. No.: 19/311,069

(22) Filed: Aug. 27, 2025

(30) Foreign Application Priority Data
Aug. 29, 2024 (FR) FR2409222

(51) Int. Cl. F17C 5/02; F17C 5/00

(52) U.S. Cl. CPC F17C 5/02; F17C 5/002; F17C 2221/012; F17C 2223/0161; F17C 2225/0161; F17C 2227/048; F17C 2250/01; F17C 2250/032; F17C 2250/043; F17C 2250/0439; F17C 2270/0139; F17C 2270/0168

(57) ABSTRACT

The invention relates to a method for delivering liquid hydrogen to at least one target tank, in a system comprising the target tank, at least one source of liquid hydrogen such as a liquefier, and at least one intermediate tank intended to be replenished by the source and intended to deliver liquid hydrogen to the target tank, the method comprising the following steps of determining an initial state vector relating to an initial state of the system; determining initial performance data, using a performance estimation model and the initial state vector; determining configuration data of the target tank, using a configuration estimation model and the initial performance data; configuring the target tank, using the configuration data, so as to allow the target tank to reach a preset thermodynamic state for the delivery of liquid hydrogen by the intermediate tank.

### CROSS REFERENCE TO RELATED APPLICATIONS

This application claims the benefit of priority under 35 U.S.C. § 119 (a) and (b) to French patent application No. FR2409222, filed Aug. 29, 2024, which is herein incorporated by reference in its entirety.

### FIELD OF THE INVENTION

The present invention relates to a method for delivering liquid hydrogen, in particular in the context of distribution of liquid hydrogen from a source to a target tank.

### BACKGROUND OF THE INVENTION

A cryogenic liquid, in particular liquid hydrogen, is produced on a production site, thus forming a source of cryogenic liquid such as a source of liquid hydrogen. The cryogenic liquid may also be stored in a storage tank by way of source.

The storage tank may be located on the production site or on a remote site. The cryogenic liquid is then distributed to users into at least one target tank. Most frequently, intermediate tanks are filled from the source with a view to subsequently filling the target tank.

It is possible for the target tank to be fixed or mobile. A mobile target tank may be moved, or indeed move, to a distribution site where it will be filled with cryogenic liquid from an intermediate tank.

The expression “intermediate tank” means any mobile or fixed tank of cryogenic liquid that is filled on a production or storage site, and from which the target tank is filled.

Examples of production or storage sites are in particular liquefaction plants and/or storage sites where the cryogenic liquid is kept in dewars. In particular, sites where the fuel tanks of vehicles are filled (such as stations for filling land vehicles with fuel, railway stations and airports, and sites for filling the fuel tanks of boats and ships) and industrial sites where cryogenic liquid is used in site operation or maintenance are examples of distribution sites.

There are particular constraints in the case of liquid hydrogen. In particular, the desire to use liquid hydrogen as a fuel, in order to meet the challenges of climate change, adds particular constraints related to its characteristics and its use.

The main problems that arise are related to the cryogenic nature of the liquid hydrogen and the holding time in tanks, in particular mobile tanks, of cryogenic liquids.

A cryogenic fluid contained in a cryogenic tank receives energy from the external environment, which is at a temperature above the temperature of the cryogenic fluid, in particular in the form of heat leaks. Because of such heat leaks in intermediate and/or target tanks, some of the cryogenic liquid boils off and generates boil-off gas (BOG). Over time, generation of this boil-off gas decreases the level of the cryogenic liquid in the tank, and increases the pressure and temperature of the cryogenic liquid in these tanks.

This may make it difficult to ensure that target tanks are filled under satisfactory conditions, i.e. under thermodynamic conditions allowing a maximum amount and ideally all of the cryogenic liquid to be extracted and used.

One known way of distributing liquid hydrogen consists in increasing or decreasing the pressure of the intermediate tank, just before delivery to a target tank, so as to make the pressure of the intermediate tank compatible with a method used to fill the target tank.

It is thus known to distribute liquid hydrogen using delivery systems in which the intermediate tank is adapted to the thermodynamic conditions of the target tank during delivery. One problem with this known solution is that the liquid hydrogen is then delivered under conditions, in particular thermodynamic conditions, that are sub-optimal with respect to how the operator of the target tank expects to use the liquid hydrogen. This leads to the loss of amounts of hydrogen, which are often released into the atmosphere, which potentially causes problems, in particular in the presence of an explosive atmosphere.

A subsequent problem arises in the case where a given intermediate tank delivers to a plurality of target tanks. Adapting the intermediate tank to the conditions of a first target tank may then prevent or make more complicated the adaptation of the same intermediate tank to the conditions of a second target tank, thus causing an increase in the amount of hydrogen lost.

A solution allowing the safety of a liquid-hydrogen system to be improved by modifying the parameters of the intermediate tank is also known from documents US2022/170597 and U.S. Pat. No. 11,796,132. Again, the target tank is considered to be a given and unchangeable element, whereas the conditions, and in particular thermodynamic conditions, of the intermediate tank are adapted to the needs of the other elements of the system.

This type of solution prevents optimization of the thermodynamic conditions of the liquid hydrogen delivered to the target tank and/or of the quality of the liquid hydrogen delivered to the target tank. This results in a loss of hydrogen, and/or venting potentially with risks, in particular risks associated with explosive atmospheres.

### SUMMARY OF THE INVENTION

The present invention aims to effectively overcome all or some of these drawbacks by providing a method for delivering liquid hydrogen to at least one target tank, in a system comprising the target tank, at least one source of liquid hydrogen such as a liquefier, and at least one intermediate tank intended to be replenished by the source and intended to deliver liquid hydrogen to the target tank, the method comprising the following steps.
Determining an initial state vector relating to an initial state of the system.
Determining initial performance data, using a performance estimation model and the initial state vector.
Determining configuration data of the target tank, using a configuration estimation model and the initial performance data.
Configuring the target tank, using the configuration data, so as to allow the target tank to reach a preset thermodynamic state for the delivery of liquid hydrogen by the intermediate tank.

By adapting the target tank to the conditions of the intermediate tank before delivery, the invention thus makes it possible to keep the liquid contained in the intermediate tank under the most favourable conditions possible, to allow optimized utilization of the target tank and limit the impact on the environment.

According to one embodiment, the initial state vector contains at least one datum relating to a thermodynamic parameter of the target tank, for example a datum relating to the pressure and/or temperature of the hydrogen in the target tank.

According to one embodiment, the intermediate tank is a mobile tank and the target tank is a fixed tank, in particular one intended to supply a consumer with hydrogen.

According to one embodiment, the initial performance data comprise an initial performance level and the method further comprises the following steps.
Determining, in particular dynamically, a current state vector relating to a current state of the system.
Determining current performance data using the performance estimation model and the current state vector, the current performance data comprising a level of current performance.
Optionally, adjusting the configuration estimation model and/or performance estimation model, using the initial state vector and/or current state vector, in particular if a difference between the initial performance level and the current performance level is greater than a first set threshold.

According to one embodiment, the method comprises the following additional steps.
Determining current configuration data using the current state vector and the adjusted configuration estimation model.
Configuring the target tank, using the current configuration data.

According to one embodiment, the configuration data comprise a parameter intended to be used in adjustment of the pressure of a vent of the target tank and/or of the temperature of the liquid contained in the target tank.

According to one embodiment, the configuration estimation model incorporates a first parameter of withdrawal from the target tank before and/or during and/or after delivery.

According to one embodiment, the step of determining configuration data of the target tank comprises the following substeps.
Determining a plurality of performance data corresponding to a plurality of possible configuration data.
Selecting configuration data from the plurality of possible configuration data.

According to one embodiment, the configuration data are determined before delivery to the target tank, and/or recursively every preset time period.

According to one embodiment, at least one of the performance estimation model and configuration estimation model incorporates ageing and/or maintenance parameters of the target tank and/or of the intermediate tank.

According to one embodiment, the initial state data, the performance data, and the configuration data are stored in one or more databases.

According to one embodiment, the configuration estimation model takes into account a parameter of withdrawal from the target tank, in particular a parameter representative of the pressure and/or temperature and/or flow rate at which the liquid is withdrawn from the target tank during its use.

According to one embodiment, the configuration estimation model comprises a model enabling comparison of the performance data.

According to one embodiment, the method comprises a step of updating the performance estimation model.

According to one embodiment, the steps of determining a current state vector, of determining current performance data, and of adjusting the configuration estimation model are executed in response to at least one of the following events: a decision by an operator; occurrence of an operation of maintenance; modification and/or addition of one of the elements of the system; verification of a preset condition, in particular passage of a preset time.

The invention further relates to a method for delivering liquid hydrogen to at least one target tank, in a system comprising the target tank, at least one source of liquid hydrogen such as a liquefier, and at least one intermediate tank intended to be replenished by the source and intended to deliver liquid hydrogen to the target tank, the method comprising the following steps.
Determining an initial state vector relating to an initial state of the system.
Determining delivery plan data with a view to delivering liquid hydrogen to the target tank by means of the intermediate tank, the delivery plan data being determined using a delivery plan generation model and the initial state vector.
Determining initial performance data, using a performance estimation model, the delivery plan data, and the initial state vector, the initial performance data comprising an initial performance level.
Carrying out at least part of the delivery plan, so as to deliver liquid hydrogen to the target tank by means of the intermediate tank.
Dynamically determining, in particular while the delivery plan is being carried out:-a current state vector of the system relating to a current state of the system;-current performance data, using the performance estimation model, the delivery plan data, and the current state vector, the current performance data comprising a current performance level.
Dynamically adjusting the delivery plan data, in particular while the delivery plan is being carried out, using the delivery plan generation model and the current state vector, if a difference between the initial performance level and the current performance level is greater than a first set threshold.

The invention thus makes it possible to deliver liquid hydrogen under better thermodynamic conditions and therefore to optimize utilization of the target tank and limit the impact on the environment.

For example, when the pressure of the gas in a tank becomes too high, it is essential to vent some of this gas to the atmosphere in order to get back to an acceptable pressure level. Such a method makes it possible to avoid releasing hydrogen into the atmosphere following unnecessary heating of the liquid, which allows all the hydrogen to be delivered.

According to one embodiment, the method comprises a step of dynamically adjusting the delivery plan generation model using the initial state vector and/or current state vector.

According to one embodiment, the method comprises a step of dynamically adjusting the performance estimation model using the initial state vector and/or current state vector.

According to one embodiment, the initial state vector and/or current state vector contain/contains at least one datum relating to the fill level and a datum relating to a thermodynamic parameter of the target tank, for example a datum relating to the pressure and/or temperature of the hydrogen in the target tank.

According to one embodiment, the initial state vector and/or current state vector contain/contains a datum relating to a need of the target tank for liquid hydrogen.

According to one embodiment, the delivery plan data comprise a plurality of tasks, in particular sequential tasks, each task comprising at least one among: movement of the intermediate tank, in particular to a set location; movement of the target tank, in particular to a set location; delivery to the target tank; refilling of the intermediate tank.

According to one embodiment, the delivery plan data define an order in which a given intermediate tank successively delivers to a plurality of target tanks.

According to one embodiment, steps b) and c) are repeated as long as the initial performance level is below a set level.

According to one embodiment, the intermediate tank is mobile and the target tank is fixed, and in particular intended to supply a consumer with hydrogen.

According to one embodiment, the initial performance data and/or current performance data comprise at least: a distance travelled by the intermediate tank; a difference between an amount of hydrogen requested by the customer to fill the target tank and an amount of hydrogen actually delivered by the intermediate tank; a ratio between an amount of hydrogen contained in the intermediate tank before the delivery plan is carried out and the actual amount of hydrogen delivered by the intermediate tank when the plan is carried out.

According to one embodiment, the target tank comprises at least one communicating sensor, in particular for measuring the fill level and/or a thermodynamic parameter of the target tank, for example a datum relating to the pressure and/or temperature of the hydrogen in the target tank.

According to one embodiment, the intermediate tank comprises at least one communicating sensor, in particular for measuring the fill level and/or a thermodynamic parameter of the intermediate tank, for example a datum relating to the pressure and/or temperature of the hydrogen in the intermediate tank.

According to one embodiment, the target tank is fixed or mobile.

According to one embodiment, the intermediate tank is fixed or mobile.

The invention may also relate to any alternative method comprising any combination of the features above or below, and in particular falling within the scope of the claims.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

The invention will be understood better on reading the following description and on studying the accompanying figures. These figures are given merely by way of illustration and do not in any way limit the invention.

FIG. 1 is a schematic and partial representation of a system for implementing a method according to the invention.

FIG. 2 is a schematic and partial representation of a method according to the invention.

FIG. 3 is a schematic and partial representation of a relationship between performance data and configuration data during the implementation of a method according to the invention.

FIG. 4 provides an embodiment of the present invention.

### DETAILED DESCRIPTION OF THE INVENTION

As illustrated in FIG. 1, the method according to the invention may be implemented in a system comprising a target tank 4, at least one source 2 of liquid hydrogen and at least one intermediate tank 3. The source 2 may for example be a hydrogen liquefier or a fixed or mobile storage of liquid hydrogen. The intermediate tank 3 is intended to be replenished by the source 2 and to deliver liquid hydrogen to the target tank 4.

The system may advantageously comprise a system for acquiring and processing data, in particular comprising a telecommunications infrastructure and a computing system. This system for acquiring and processing data preferably comprises at least one microprocessor.

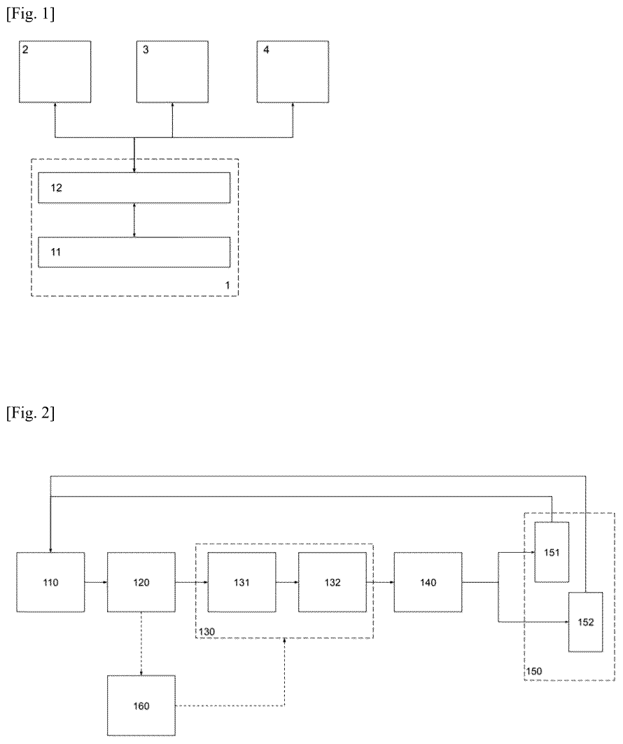

One example of a method according to the invention is illustrated in FIG. 2. The method allows delivery 151, 152 of liquid hydrogen to at least one target tank 4, and comprises the following steps, which may be successive.

Determining 110 an initial state vector relating to an initial state of the system. This vector may in particular contain data on the target tank 4, the intermediate tank 3, the delivery plan of the intermediate tank, the road network, etc.

Determining 120 initial performance data 20, using a performance estimation model and the initial state vector.

Determining 130 configuration data 30 of the target tank 4, using a configuration estimation model and the initial performance data 20.

Configuring 140 the target tank 4, using the configuration data 30, so as to allow the target tank 4 to reach a preset thermodynamic state for the delivery 151, 152 of liquid hydrogen by the intermediate tank 3.

Thus, during delivery 151, 152, the thermodynamic conditions of the liquid contained in the intermediate tank 3 are preserved, and delivery 151, 152 to the target tank 4 is optimized.

According to one embodiment, the initial state vector contains at least one datum relating to a thermodynamic parameter of the target tank 4, for example a datum relating to the pressure and/or temperature of the hydrogen in the target tank 4.

According to one embodiment, the method is implemented using an intermediate tank 3 that is a mobile tank and a target tank 4 that is a fixed tank.

The target tank 4 may in particular be intended to supply a consumer with hydrogen. For example, the target tank 4 may be the storage of liquid hydrogen in a vehicle filling station, or else the storage of liquid hydrogen of an industrial consumer site.

According to one embodiment, the initial performance data comprise an initial performance level and the method further comprises the following steps.

Determining 110, in particular dynamically, a current state vector relating to a current state of the system.

Determining 120 current performance data 20, using the performance estimation model and the current state vector. The current performance data advantageously comprise a current performance level.

Optionally, adjusting 160 the configuration estimation model and/or performance estimation model, using the initial state vector and/or current state vector. This adjusting step 160 is in particular executed if a difference between the initial performance level 20 and the current performance level 20 is greater than a first set threshold.

According to one embodiment, the method comprises the following additional steps.

Determining 130 current configuration data 30 using the current state vector and the adjusted configuration estimation model.

Configuring 140 the target tank, using the current configuration data.

Thus, the thermodynamic state of the target tank 4 may be subsequently adapted to a change in state of the system and the delivery 151, 152 of liquid hydrogen by the intermediate tank 3 subsequently improved.

According to one embodiment, the configuration data 30 comprise a parameter intended to be used in adjustment of the pressure of a vent of the target tank 4 and/or of the temperature of the liquid contained in the target tank 4.

According to one embodiment, the configuration estimation model incorporates a first parameter of withdrawal from the target tank 4 before and/or during and/or after delivery 151, 152.

According to one embodiment, the step 130 of determining configuration data of the target tank 4 comprises the following substeps.

Determining 131 a plurality of performance data 20 corresponding to a plurality of possible configuration data 31.

Selecting 132 configuration data 32 from the plurality of possible configuration data 31.

In particular, the configuration data applied in step 140 are a subset of the configuration data 32 that allow the system to perform.

The performance data 20 may comprise performance data relating to different first and second quantities, in particular physical quantities. It may, by way of example, be a an amount of hydrogen vented by the user of the target tank 4, an amount of hydrogen vented by the operator of the intermediate tank 3, and/or the flow rate of a pump used to withdraw liquid hydrogen from the target tank 4.

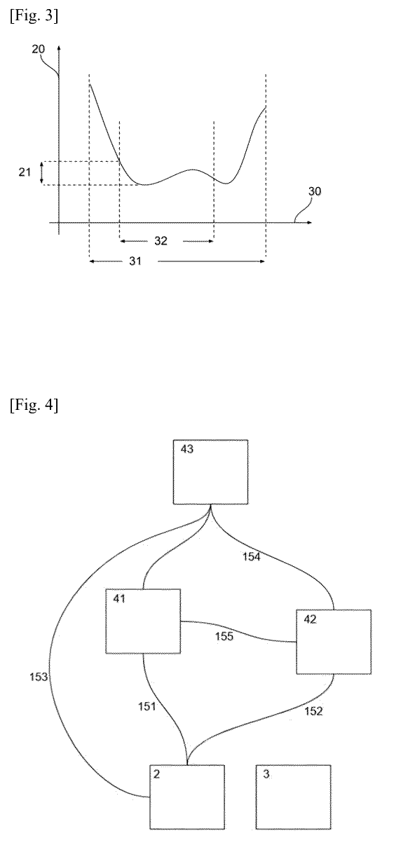

The selecting step 132 may then consist in selecting configuration data 32 allowing the performance data 21 regarding the second quantity to be optimized, from possible configuration data 31 corresponding to acceptable values of the performance data 20 regarding the first quantity. The principle is shown schematically in FIG. 3.

According to one embodiment, the configuration data 30 are determined before delivery to the target tank 4, and/or recursively every preset time period. This preset time period may in particular be equal to one or more weeks, months or years.

According to one embodiment, at least one of the performance estimation model and configuration estimation model incorporates ageing and/or maintenance parameters of the target tank 4 and/or of the intermediate tank 3.

According to one embodiment, the initial state data, the performance data 20 and the configuration data 30 are stored in one or more databases that form part of the computing system 11 or communicate with said computing system 11.

According to one embodiment, the configuration estimation model takes into account a parameter of withdrawal from the target tank 4, in particular a parameter representative of the pressure and/or temperature and/or flow rate at which the liquid is withdrawn from the target tank 4 during its use.

According to one embodiment, the configuration estimation model comprises a model enabling comparison of the performance data.

According to one embodiment, the method comprises a step 160 of updating the performance estimation model.

According to one embodiment, the steps of determining 110 a current state vector, of determining 120 current performance data, and of adjusting 160 the configuration estimation model are executed in response to at least one of the following events: a decision by an operator; occurrence of an operation of maintenance, modification and/or addition of one of the elements of the system; and verification of a preset condition, in particular passage of a preset time.

An example of a method according to the invention is shown in FIG. 4 and will be described in the following paragraphs. It concerns a system comprising one liquid hydrogen source 2 and one intermediate tank 3 that is a liquid hydrogen trailer. Such liquid hydrogen trailer 3 is filled at the source 2 and is used to deliver liquid hydrogen to three target tanks 41, 42, 43, which may be the liquid storage tanks of three different hydrogen refueling stations.

The lines 151, 152, 153, 154, 155 connecting the target tanks 41, 42, 43 and the source 2 represent respective delivering steps 151, 152, 153, 154, 155 executed after the intermediate tank 3 has moved from the source 2 to one of the target tanks 41, 42, 43 or from one of the target tanks 41, 42, 43 to another of the target tanks 41, 42, 43.

In this example, the step of determining 110 an initial state vector relating to an initial state of the system will include determining one or more among the following: the availability, traffic charge and estimated travel time for the routes corresponding to deliveries 151, 152, 153, 154, 155; the production cost of the liquid hydrogen charged in the intermediate tank 3; the quantity of liquid hydrogen that needs to be delivered to each target tank 41, 42, 43; the temperature and/or the pressure in each target tank 41, 42, 43; the forecast liquid hydrogen consumption of the operator of each target tank 41, 42, 43.

The step of determining 120 initial performance data 20 will compute the respective cost for each combination of delivery steps that allows for the delivery of the three target tanks 41, 42, 43. The cost will take into account the transport cost related to the travel from the source 2 to the target tanks and from one target tank to another. The cost will also take into account the operation cost related to BOG generation and to the quantity of hydrogen lost by each target tank 41, 42, 43 between two successive delivering steps 150 of the same. In some embodiments, a total cost corresponding to the sum of the transport cost plus the operation cost will be computed or estimated.

The step of determining 130 the configuration data 30 will include the selection of the combination of delivery steps that provides the best performance.

One possible manner of determining 130 the configuration data 30, may be to select the combination of delivery parameters that minimises the transport cost, while keeping the operation cost of each target tank below a previously defined cost threshold.

After the configuration data 30 has been determined, each target tank 41, 42, 43 will be configured 140 accordingly. For example, the pressure in each target tank will be set to a value corresponding to the configuration data 30. In order to do this, each target tank 41, 42, 43 receives the configuration data 30 and is configured 140 before the delivery step 151, 152, 153, 154, 155.

In a preferred embodiment, the configuration data 30 is determined 130, the target tank receives it 140, after the intermediate tank 3 has arrived at the location of the target tank. This allows to update the configuration data 30 after each delivery 150 and better account for modifications of the state of the system.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A method for delivering liquid hydrogen to a target tank, wherein the target tank is part of a system that further comprises a source of liquid hydrogen, and an intermediate tank configured to be replenished by the source and configured to deliver liquid hydrogen to the target tank, the method comprising the following steps:
determining, via a computing system, an initial state vector relating to an initial state of the system;
determining, via the computing system, initial performance data, using a performance estimation model and the initial state vector;
determining configuration data of the target tank, using a configuration estimation model and the initial performance data;
configuring the target tank, using the configuration data before the delivery of liquid hydrogen by the intermediary tank, so as to allow the target tank to reach a preset thermodynamic state.

2. The method according to claim 1, wherein the initial state vector contains at least one datum relating to a thermodynamic parameter of the target tank, the thermodynamic parameter selected from the group consisting of a pressure of hydrogen in the target tank, a temperature of hydrogen in the target tank, a fill level of the target tank, and combinations thereof.

3. The method according to claim 2, wherein the datum relates to the pressure and/or temperature of the hydrogen in the target tank.

4. The method according to claim 1, wherein the intermediate tank is a mobile tank and the target tank is a fixed tank at a vehicle refuelling station.

5. The method according to claim 1, wherein the initial performance data comprise an initial performance level, the method further comprising:
determining, in particular dynamically, a current state vector relating to a current state of the system;
determining current performance data using the performance estimation model and the current state vector, the current performance data comprising a current performance level;
optionally, adjusting the configuration estimation model and/or performance estimation model, using the initial state vector and/or current state vector, in particular if a difference between the initial performance level and the current performance level is greater than a first set threshold.

6. The method according to claim 5, further comprising the following additional steps:
determining current configuration data using the current state vector and the adjusted configuration estimation model;
configuring the target tank, using the current configuration data.

7. The method according to claim 1, wherein the configuration data comprise a parameter intended to be used in adjustment of the pressure of a vent of the target tank and/or of the temperature of the liquid contained in the target tank.

8. The method according to claim 1, wherein the configuration estimation model incorporates a first parameter of withdrawal from the target tank before and/or during and/or after delivery.

9. The method according to claim 1, wherein the step of determining configuration data of the target tank comprises the following substeps:
determining a plurality of performance data corresponding to a plurality of possible configuration data;
selecting configuration data from the plurality of possible configuration data.

10. The method according to claim 1, wherein the configuration data are determined before delivery to the target tank, and/or recursively every preset time period.

11. The method according to claim 1, wherein at least one of the performance estimation model and configuration estimation model incorporates ageing and/or maintenance parameters of the target tank and/or of the intermediate tank.

12. The method according to claim 1, wherein the initial state vector further comprises at least one datum related to a state of the intermediate tank, the datum selected from the group consisting of a pressure of hydrogen in the intermediate tank, a temperature of hydrogen in the intermediate tank, and a fill level of the intermediate tank.

13. The method of claim 1, wherein the initial state vector further comprises logistical data, the logistical data comprising an estimated travel time for the intermediate tank to reach the target tank.

14. The method of claim 1, wherein the performance data is indicative of an estimated boil-off gas (BOG) generation, and wherein the configuration data is determined to minimize the estimated BOG generation during and after the delivery.

15. The method of claim 1, wherein the configuration data comprises a pressure setpoint for a vent of the target tank.

16. The method of claim 15, wherein the step of configuring the target tank comprises actively venting the target tank to the pressure setpoint.

17. The method of claim 1, wherein the performance estimation model and the configuration estimation model are machine-learning models that are updated based on historical delivery data.

18. The method of claim 1, wherein the target tank and the intermediate tank comprise communicating sensors, and wherein the initial state vector is determined using real-time data transmitted from the communicating sensors.

19. The method of claim 1, wherein the system comprises a plurality of target tanks, and wherein the configuration data further comprises an optimized delivery order for the intermediate tank to deliver liquid hydrogen to the plurality of target tanks.
